(19) United States
(12) Patent Application Publication
(10) Pub. No.: US 2011/0074706 A1
(43) Pub. Date: Mar. 31, 2011

(54) TOUCH SCREEN DEVICE

(76) Inventors: Yeon Ho SON, Gyunggi-do (KR); Jae Kyung KIM, Gyunggi-do (KR); Dong Sun PARK, Seoul (KR)

(21) Appl. No.: 12/725,316

(22) Filed: Mar. 16, 2010

(30) Foreign Application Priority Data
Sep. 29, 2009 (KR) 10-2009-0092543

(51) Int. Cl. G08B 6/00; G06F 3/041

(52) U.S. Cl. 345/173; 340/407.2

(57) ABSTRACT

Disclosed herein is a touch screen device. The touch screen device includes a casing, a touch panel module, vibration generation means, a vibration motor, and a drive unit. The casing defines an internal space. The touch panel module is provided in an upper portion of the casing, and receives external touch input from a user. The vibration generation means is mounted under the touch panel module, and generates vibrations. The vibration motor is mounted on an inner side of the casing, and makes the casing vibrate. The drive unit is installed inside the casing, and, when the touch panel module is touched, generates an operating frequency corresponding to the touch and then operates the vibration motor and the vibration generation means at the generated operating frequency.

### CROSS REFERENCE TO RELATED APPLICATION

This application claims the benefit of Korean Patent Application No. 10-2009-0092543, filed on Sep. 29, 2009, entitled “Touch Screen Device,” which is hereby incorporated by reference in its entirety into this application.

### BACKGROUND OF THE INVENTION

1. Technical Field

The present invention relates generally to a touch screen device.

2. Description of the Related Art

In order to meet users' demands for the convenient use of electronic products, the use of touch screens which enable users to perform input by touching electronic products has become popularized. Touch screen devices are based not only on the concept of performing input using touching but also on the concept of incorporating users' intuitive experiences into an interface and diversifying feedback.

Touch screen devices not only have the advantages of reducing the space required to use, improving manipulability, realizing convenience, facilitating the change of specifications and increasing users' understandability, but also have the advantage of facilitating compatibility with Information Technology (IT) devices. Thanks to these advantages, they are widely used in various fields such as the industry, traffic, service, medical and mobile fields.

As shown in FIG. 5, a conventional touch screen device 10 includes a main body 11, a touch screen panel 12 placed in the upper portion of the main body 11, and a motor 13 mounted on an inner side of the main body 11.

The touch screen panel 12 is a part to which touch pressure is applied by a user. The motor 13 is a device which is mounted on an inner side of main body 11 and generates vibrations, and a vibration motor or linear motor is used as the motor 13.

As described above, the motor 13 is mounted on the inner side of the main body 11. Accordingly, when a user touches the top of the touch screen panel 12, vibrations are smoothly transmitted to the main body 11, but vibrations are not smoothly transmitted to the touch screen panel 12.

As a result, there is a pressing need to develop a touch screen device capable of maximizing the magnitude of vibration applied when a user touches the touch screen panel 12.

### SUMMARY OF THE INVENTION

Accordingly, the present invention has been made keeping in mind the above problems occurring in the prior art, and the present invention is intended to provide a touch screen device capable of maximizing the magnitude of vibration applied when a user touches a touch panel module.

In order to accomplish the above object, the present invention provides a touch screen device, including a casing configured to define an internal space; a touch panel module provided in an upper portion of the casing, and configured to receive external touch input from a user; vibration generation means mounted under the touch panel module, and configured to generate vibrations; a vibration motor mounted on an inner side of the casing, and configured to make the casing vibrate; and a drive unit installed inside the casing, and configured to, when the touch panel module is touched, generate an operating frequency corresponding to the touch and then operate the vibration motor and the vibration generation means at the generated operating frequency.

The touch panel module may include a touch screen panel and an image display unit mounted under the touch screen panel.

The touch panel module may be formed by integrating the touch screen panel and the image display unit into a single body.

The vibration generation means may be a piezoelectric actuator.

When a designer intends to emphasize another vibration effect in addition to feedback to being touched, the drive unit may generate a frequency which is the same as the resonant frequency of the vibration motor and supply the generated frequency to the vibration motor and the vibration generation means.

The vibration motor and the vibration generation means may be operated at the same frequency and generate vibrations.

The vibrations may be applied to the casing and the touch panel module by the vibration motor and the vibration generation means.

When a designer intends to emphasize a vibration effect of feedback to being touched, the drive unit may generate a frequency different from a resonant frequency of the vibration motor and supply the generated different frequency to the vibration generation means.

The vibration generation means may be operated at the different frequency and generate the vibrations.

The vibrations may be applied to the touch panel module by the vibration generation means.

The vibration motor may be a linear vibration motor.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic side view showing a touch screen device according to the present invention;

FIG. 2 is a sectional view showing a vibration motor according to the present invention;

FIG. 3 is a flowchart showing the operation of the touch screen device according to the present invention;

FIG. 4 is a graph showing the performance of the touch screen device according to the present invention; and

FIG. 5 is a sectional view showing a conventional touch screen device.

### DESCRIPTION OF THE PREFERRED EMBODIMENTS

Reference now should be made to the drawings, in which the same reference numerals are used throughout the different drawings to designate the same or similar components. Furthermore, in the following description of the present invention, if detailed descriptions of related known technologies may make the gist of the present invention obscure, the detailed descriptions will be omitted.

Preferred embodiments of the present invention will be described in detail with reference to the accompanying drawings.

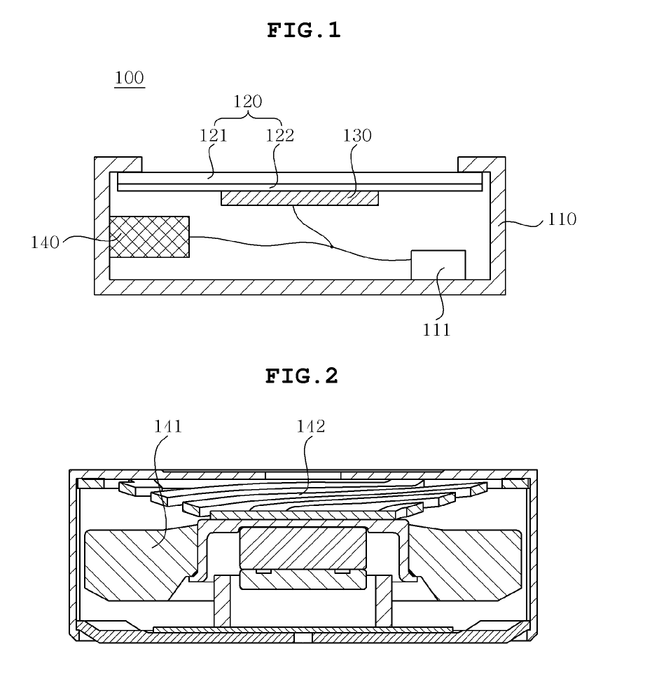

FIGS. 1 and 2 show a touch screen device 100 according to a preferred embodiment of the present invention. The touch screen device 100 includes a casing 110, a touch panel module 120, vibration generation means 130, and a vibration motor 140.

The casing 110 defines an internal space, and functions to form the outermost cover of the touch screen device 100 and offer protection against external impact.

The touch panel module 120 includes a touch screen panel 121 and an image display unit 122 disposed under the touch screen panel 121. The touch screen panel 121 is transparent and flexible, and functions as a signal input surface on which a user can perform touch manipulation while viewing images displayed on the image display unit 122 disposed under the touch screen panel 121.

For example, the touch screen panel 121 is formed by laying an external film layer, an Indium Tin Oxide (ITO) film layer and a base film layer one on top of another.

Here, the external film layer is disposed on the front surface of a mobile communication terminal, and is divided into a viewing area configured to receive touch input and a dead space area formed around the viewing area. Meanwhile, the external film layer is made of, for example, transparent film material such as Poly Ethylene Terephtalate (PET) to enable a user to view the screen of the image display unit 122.

Although the Indium-Tin-Oxide (ITO) film layer is not illustrated in detail, it is configured in such a way that two upper and lower film layers are laid one on top of another and a dot spacer is provided therebetween to maintain a uniform interval. Electrode membranes in which conductive X-axis and Y-axis patterns have been formed are provided along the peripheries of the film layers, and the X-axis and Y-axis patterns are electrically separated by insulators (not shown). The electrode membranes are exposed to the outside of the ITO film layer via a Flexible Printed Circuit (FPC) cable, and are electrically connected to a mobile terminal.

The base film layer functions to support the entire touch panel, and may be formed of, for example, a glass substrate with excellent transmittance and excellent touch response speed.

The image display unit 122 disposed under the touch screen panel 121 includes one or more layers, and functions to convert various types of electrical information generated by various types of devices into visual information by changing the transmittance of a liquid crystal through altering the applied voltage and then transmit the resulting information.

The touch screen panel 121 and the image display unit 122 may be integrated into a single structure.

The single integrated structure of the touch screen panel 121 and the image display unit 122 has the advantages of being highly efficient to manufacture and being very resistant to external impact compared with separated structures.

The vibration generation means 130 is mounted under the touch panel module 120, applies a vibrating sensation by extracting or expanding in the longitudinal direction in response to external power, and may be formed of a piezoelectric or polymer actuator which may be formed to be thin.

Although the vibration generation means 130 is not limited to a specific shape or a size, it is normally formed in a thin rod shape. Furthermore, although the mounting location of the vibration generation means 130 is also not limited, it is generally mounted under the touch panel module 120 so as to apply the strongest vibrating sensation to a user.

The vibration motor 140 is mounted on an inner side of the casing 110, and generates vibrations. A linear vibration motor may be used as the vibration motor 140.

FIG. 2 is a detailed view showing the internal structure of a linear vibration motor when the vibration motor 140 is a linear vibration motor. Here, a resonant frequency is designed by adjusting the magnitude of a weight 141 and the elastic modulus of a spring 142, and the magnitude of vibration is maximized by applying an appropriate frequency.

As described above, the vibration motor 140 is an actuator for reception using the resonance between the spring 142 and the weight 141, and is generally designed to operate at an operating frequency within a range of 150˜200 Hz.

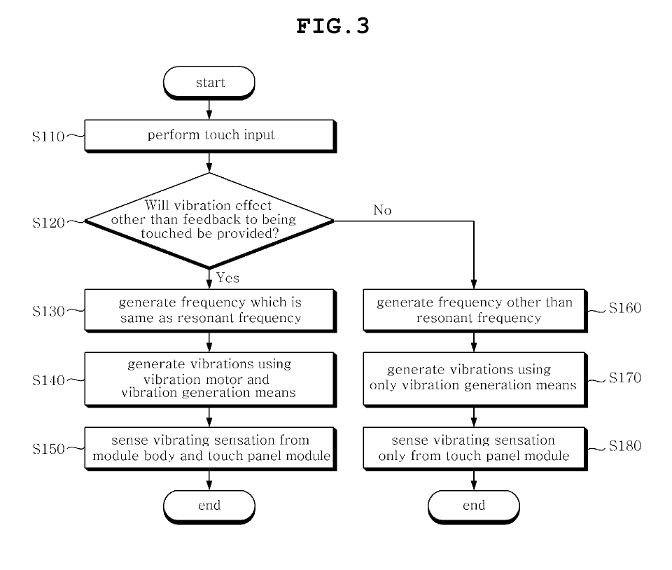

FIG. 3 is a flowchart showing a method of operating the vibration generation means 130 and the vibration motor 140 using touching. When the touch panel module 120 is touched by a user at step S110, whether a designer intends to emphasize another vibration effect in addition to feedback to being touched, such as text, is determined at step S120.

Here, the drive unit 111 is installed inside the casing 110. When the touch panel module 120 is touched, the drive unit 111 generates an operating frequency corresponding to the touch, and operates the vibration motor 140 and the vibration generation means 130 at the generated operating frequency.

When a designer intends to emphasize another vibration effect in addition to feedback to being touched, the drive unit 111 generates an operating frequency which is the same as the resonant frequency of the vibration motor 140, and supplies the same operating frequency to the vibration motor 140 and the vibration generation means 130 at step S130.

Accordingly, the vibration motor 140 and the vibration generation means 130 operate at the same operating frequency (that is, a resonant frequency), and generate vibrations at step S140.

As a result, since vibrations are transferred through the casing 110 and the touch panel module 120 and the vibrations resonate with each other, a user senses the strongest magnitude of vibration transferred through the casing 110 and the touch panel module 120 at step S150.

Meanwhile, when a designer intends to emphasize only the vibration effect of the feedback to being touched, the drive unit 111 generates an operating frequency other than the resonant frequency of the vibration motor 140, and supplies the operating frequency to the vibration motor 140 and the vibration generation means 130 at step S160.

Accordingly, vibrations are generated only by the vibration generation means 130 at step S170.

As a result, since vibrations are transferred only through the touch panel module 120 and the vibrations resonate with each other, a user can sense only the vibrations transferred through the touch panel module 120 at step S180.

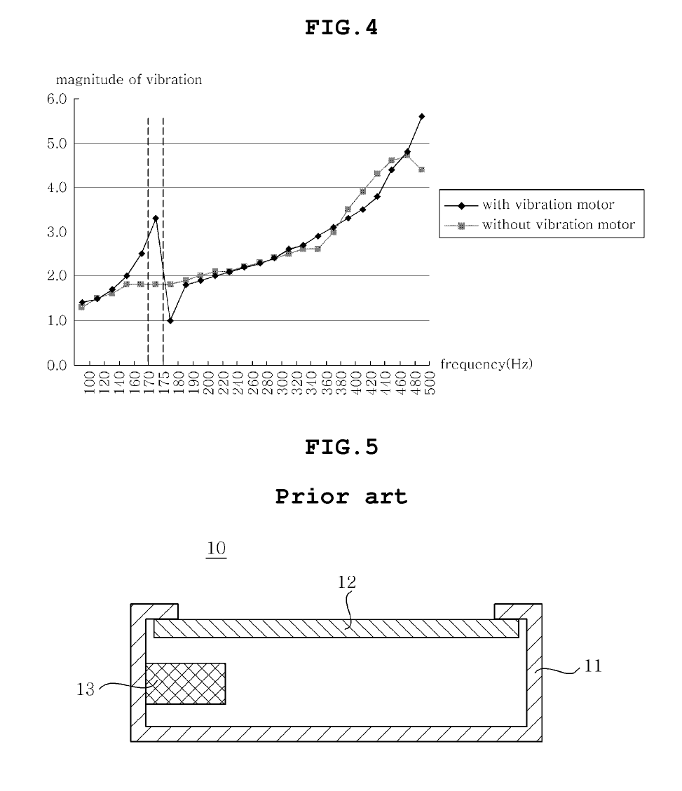

FIG. 4 is a graph showing the comparison between the magnitude of vibration of the touch screen device 100 equipped with the vibration motor 140 designed for a resonance point of about 175 Hz and the magnitude of vibration of the touch screen device 100 not equipped with the vibration motor 140 on the basis of frequency.

As shown in the graph, in the case of the touch screen device 100 equipped with the vibration motor 140 designed for a resonance point of about 175 Hz, when the resonant frequency is about 175 Hz, the magnitude of vibration applied by the vibration motor 140 to the casing 110 and the magnitude of vibration of the vibration generation means 130 are highest.

In this case, vibration force generally has a maximum value within the range of 150˜300 Hz, that is, the range of operating frequencies of a haptic actuator, and can impart the strongest vibrating sensation when the touch panel module 120 is touched.

Furthermore, since the vibration motor 140 is mounted on the casing 110 and the vibration generation means 130 is mounted under the touch screen panel 120, a vibrating sensation can be maximized not only from the casing 110 of the touch screen device 100 but also from the touch panel module 120 of the touch screen device 100.

Here, in order to allow a vibrating sensation to be sensed only from the touch module panel 120, a frequency other than the resonant frequency of the vibration motor 140 may be applied.

In the touch screen device 100 configured as described above, the vibration generation means 130 is mounted on the touch panel module 120, and the vibration motor 140, which is a receiving actuator using the resonance between the spring and the vibration mass, is installed inside the casing 110, thereby enabling a user to sense the strongest vibrating sensation.

As described above, according to the present invention, the vibration generation means is mounted on the touch panel module, the vibration motor, which is a receiving actuator using the resonance between a spring and a vibration mass, is installed in the casing, and the drive unit is installed inside the casing.

Here, when a vibration effect other than feedback to being touched is desired to be emphasized, the drive unit generates a frequency which is the same as the resonant frequency of the vibration motor, and supplies the generated frequency to the vibration motor and the vibration generation means.

Furthermore, when a designer intends only to emphasize the vibration effect of feedback to being touched, the drive unit generates a frequency other than the resonant frequency of the vibration motor, and supplies the generated frequency to the vibration motor and the vibration generation means.

When a frequency which is the same as the resonant frequency of the vibration motor is generated and supplied to the vibration motor and the vibration generation means, a user can sense the strongest vibrating sensation from the casing and the touch panel module at the same time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A touch screen device, comprising:
a casing configured to define an internal space;
a touch panel module provided in an upper portion of the casing, and configured to receive external touch input from a user;
vibration generation means mounted under the touch panel module, and configured to generate vibrations;
a vibration motor mounted on an inner side of the casing, and configured to make to the casing vibrate; and
a drive unit installed inside the casing, and configured to, when the touch panel module is touched, generate an operating frequency corresponding to the touch and then operate the vibration motor and the vibration generation means at the generated operating frequency.

2. The touch screen device as set forth in claim 1, wherein the touch panel module comprises a touch screen panel and an image display unit mounted under the touch screen panel.

3. The touch screen device as set forth in claim 2, wherein the touch panel module is formed by integrating the touch screen panel and the image display unit into a single body.

4. The touch screen device as set forth in claim 1, wherein the vibration generation means is a piezoelectric actuator.

5. The touch screen device as set forth in claim 1, wherein the drive unit, when a designer intends to emphasize another vibration effect in addition to feedback to being touched, generates a frequency which is the same as a resonant frequency of the vibration motor and supplies the generated frequency to the vibration motor and the vibration generation means.

6. The touch screen device as set forth in claim 5, wherein the vibration motor and the vibration generation means are operated at the same frequency and generate vibrations.

7. The touch screen device as set forth in claim 5, wherein the vibrations are applied to the casing and the touch panel module by the vibration motor and the vibration generation means.

8. The touch screen device as set forth in claim 1, wherein the drive unit, when a designer intends to emphasize a vibration effect of feedback to being touched, generates a frequency different from a resonant frequency of the vibration motor and supplies the generated different frequency to the vibration generation means.

9. The touch screen device as set forth in claim 8, wherein the vibration generation means is operated at the different frequency and generates the vibrations.

10. The touch screen device as set forth in claim 8, wherein the vibrations are applied to the touch panel module by the vibration generation means.

11. The touch screen device as set forth in claim 1, wherein the vibration motor is a linear vibration motor.
